(19) United States
(12) Patent Application Publication
(10) Pub. No.: US 2022/0305522 A1
(43) Pub. Date: Sep. 29, 2022

(54) MASKING PAPER PROTECTION TECHNOLOGY FOR ELECTRONIC COMPONENT

(71) Applicant: Dongguan Littelfuse Electronics Company Limited, Dongguan City (CN)

(72) Inventors: Dongjian SONG, Dongguan City (CN); Liang GU, Dongguan City (CN); Werner Johler, Dongguan City (CN)

(73) Assignee: Dongguan Littelfuse Electronics Company Limited, Dongguan City (CN)

(21) Appl. No.: 17/825,237

(22) Filed: May 26, 2022

Related U.S. Application Data
(63) Continuation of application No. PCT/CN2020/122318, filed on Oct. 21, 2020.

(51) Int. Cl. B05D 1/32; B05C 21/00

(52) U.S. Cl. CPC B05D 1/325; B05C 21/005

(57) ABSTRACT

A spray coating protection method for electronic devices during metallic particle deposition via spraying is disclosed. The spray coating protection method enables selectivity over the size and location of particle deposition. The spray coating protection method is easy for an automation application, in which multiple electronic devices are processed simultaneously, and is suitable for electronic devices of different shapes and sizes. The spray coating protection method provides resistance to high temperature and high pressure during the spraying operation. The spray coating protection method utilizes masking paper, but additional film materials may be used, both to increase the protective strength of the mask and to enable easy placement and subsequent peel off of the masking paper following the spraying process. The masking paper may be made using a die cutting process and is easily placed onto the electronic device surface to ensure zero contamination from hot and high pressure spray particles.

### FIELD OF THE DISCLOSURE

Embodiments of the present disclosure relate to the spray application of electrodes on electronic devices and, more particularly, to a technique for the efficient and cost-effective spray application of multiple electronic devices.

### BACKGROUND

A Metal Oxide Varistor (MOV) is a semiconductor device that provides over-voltage protection by means of voltage clamping. The resistance material is a metallic oxide, such as zinc oxide, which is pressed into a ceramic or ceramic-like material to form a core. Additional filler material may be included in the core to form junctions between the metallic oxide grains. MOVs usually have radial leads, each of which is connected to a metallic electrode on opposing sides of the core, and the MOVs are generally coated with an epoxy or epoxy-like material.

One method for adding the metallic electrodes to the MOV is to use an arc spray or flame spray process, mechanisms to deposit molten metallic particles on the MOV. Some portion of the core of the MOV would be coated with the molten metallic particles, thus forming an electrode in a first location of the core. A second electrode may be sprayed onto the MOV at a different location of the core, such as on the opposite side, with the electrode positions being based on the shape of the MOV core.

For efficiency, it is likely that the process would be automated, with multiple MOVs being assembled and spray coated at once. A traditional protection for performing the arc spray coating, for example, is to use a metal fixture during the automation process, so as to limit the locations in which the molten metallic particles are deposited. For example, where the MOV core is a round disk, the metal fixture may include rows and columns of holes that have slightly smaller diameters than that of the MOVs. By positioning the metal fixture over the assemblage of MOV cores, the metal fixture controls where the molten metallic particles are deposited during the spraying process.

The traditional mechanism for spray deposition of electrodes unfortunately results in frequent cleaning of the metal fixture. Further, it is difficult to clean the hole wall surface of the metal fixture, which increases the cost of manufacturing the MOVs. The process for adding electrodes to an assemblage of MOV devices is thus made more tedious, due to the cleanup involved.

It is with respect to these and other considerations that the present improvements may be useful.

### SUMMARY

This Summary is provided to introduce a selection of concepts in a simplified form that are further described below in the Detailed Description. This Summary is not intended to identify key or essential features of the claimed subject matter, nor is it intended as an aid in determining the scope of the claimed subject matter.

An exemplary embodiment of a masking paper protection method is disclosed. The masking paper protection method includes inserting an electronic device into a receptacle of a blind hole pallet. The blind hole pallet has multiple receptacles for receiving multiple electronic devices. The method also includes covering the blind hole pallet with masking paper. An assembly including the electronic device, the blind hole pallet and the masking paper is formed. The assembly is then sprayed with metallic material. Finally, the masking paper is removed.

An exemplary embodiment of a second masking paper protection method is disclosed. A top surface of an electronic device is covered with a first masking paper. A bottom surface of the electronic device is covered with a second masking paper. An assembly made up of the electronic device, the first masking paper, and the second masking paper is formed. The assembly is sprayed with metallic material. The first and second masking papers are removed from the electronic device.

An exemplary embodiment of a third masking paper protection method is disclosed. An electronic device is inserted into a receptacle of a through hole pallet, which includes multiple receptacles for multiple electronic devices. A top surface of the through hole pallet is covered with first masking paper and a bottom surface of the through hole pallet is covered with second masking paper. An assembly consisting of the electronic device, the through hole pallet, the first masking paper, and the second masking paper is formed. The assembly is sprayed with metallic material, and the first and second masking papers are removed.

### BRIEF DESCRIPTION OF THE DRAWINGS

FIGS. 1A and 1B are diagrams illustrating a traditional spray coating protection operation for coating electronic devices, according to the prior art;

FIGS. 2A, 2B, and 2C are diagrams illustrating different views of an electronic device upon which electrodes are sprayed, in accordance with exemplary embodiments;

FIG. 3 features images of pallets used during traditional spray coating operations, in accordance with exemplary embodiments;

FIGS. 4A, 4B, and 4C are diagrams illustrating a masking paper protection method, for coating electronic devices, according to exemplary embodiments;

FIGS. 5A, 5B, and 5C are diagrams illustrating a masking paper protection method, for coating electronic devices, according to exemplary embodiments;

FIGS. 6A, 6B, and 6C are diagrams illustrating a masking paper protection method, for coating electronic devices, according to exemplary embodiments;

FIG. 7 is a pictorial flow diagram of a masking paper protection method, according to exemplary embodiments; and

FIG. 8 is a representative drawing of the covering used by the masking paper protection method, according to exemplary embodiments.

### DETAILED DESCRIPTION

A spray coating protection method for metal oxide varistor (MOV) parts and other electronic components during metallic particle deposition via spraying is disclosed herein. The spray coating protection method enables selectivity over the size and location of particle deposition. The spray coating protection method is easy for an automation application, in which multiple MOVs are processed simultaneously, and is suitable for MOV chips of different shapes and sizes. Further, the spray coating protection method provides resistance to high temperature and high pressure during the spraying operation. The spray coating protection method utilizes masking paper, but additional film materials may be used, both to increase the protective strength of the mask and to enable easy placement and subsequent peel off of the masking paper following the spraying process. The masking paper may be made using a die cutting process and is easily placed onto the MOV disk surface to ensure zero contamination from very hot and high pressure spray particles.

The spray coating protection method described herein may utilize arc spraying, which utilizes an arc point created between two electrically conductive wires. The arc allows heating, which causes the metallic material to melt. Compressed air is also used for spraying the metallic material. Alternatively, the spray coating protection method may utilize flame spraying which utilizes a flame, which is generated using oxygen combined with fuel, to heat the metallic material. References to “spray coating” in this disclosure is meant to include either arc spraying or flame spraying.

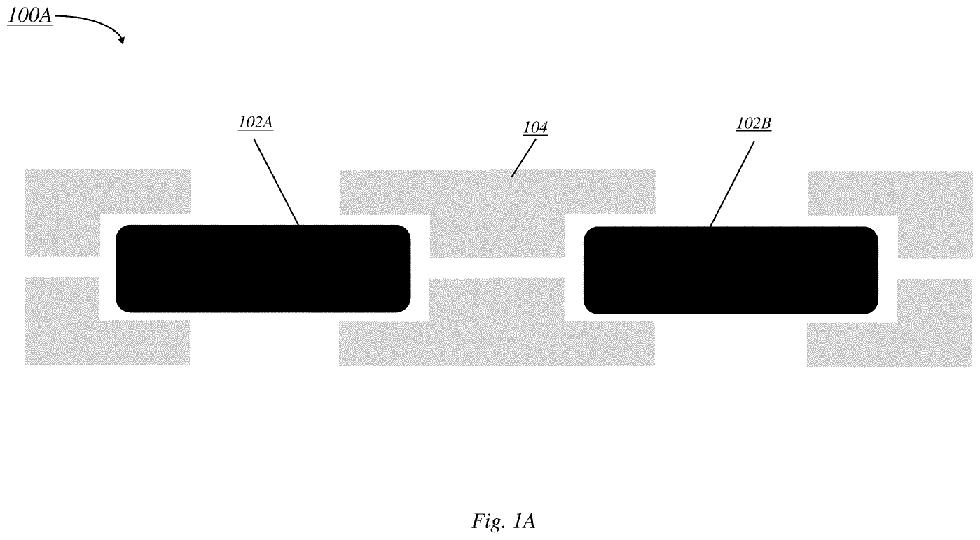

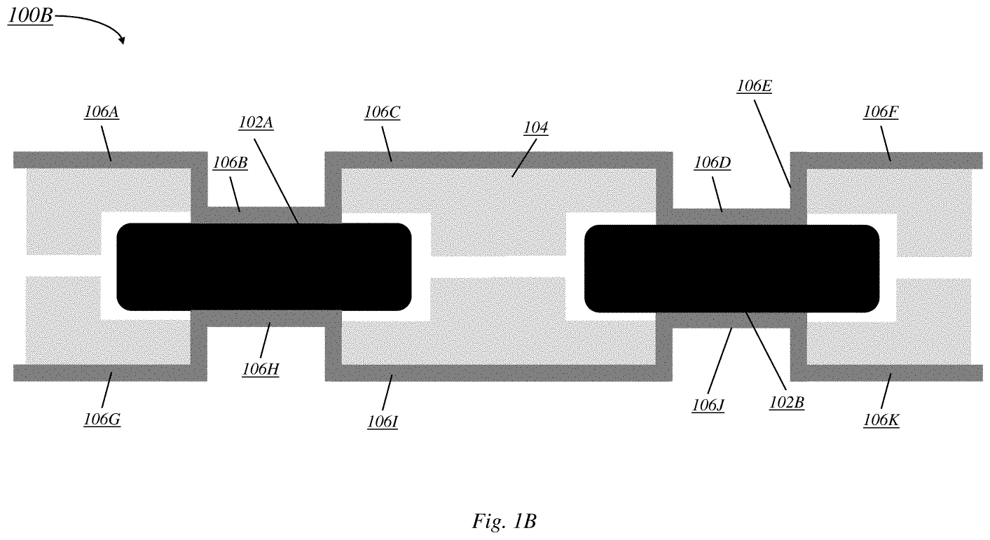

FIGS. 1A and 1B are representative drawings illustrating a traditional spray coating protection operation 100, for coating electronic devices with metallic material, according to the prior art. FIG. 1A shows the operation 100A before spray coating and FIG. 1B shows the operation 100B after spray coating. FIG. 1A shows two electronic devices 102A and 102B (collectively, “electronic devices 102”), such as MOVs, that may be two devices of a multiple-device spraying operation. The two electronic devices 102 are disposed within a fixture 104, such as a pallet especially designed for holding multiple electronic devices. In this example, the pallet 104 is known as a through-hole pallet because the electronic devices 102 are visible both from a top side of the pallet and a bottom side of the pallet.

FIG. 1B again shows the two electronic devices 102, this time following the traditional spray coating operation 100B. A metallic material 106 is spray deposited over the entire device-plus-pallet assembly surface, top and bottom, consisting of the two electronic devices 102 and the pallet 104. The metallic material 106 is separated into distinct metallic material surface deposits 106A-106K. The objective of the spray coating operation, however, is to coat opposite surfaces of the two electronic devices 102. Thus, the metallic material surface deposits 106B, 106D, 106H, and 106J are the desired result of the spray coating operation while the metallic material surface deposits 106A, 106C, 106E, 106F, 106G, 106I, and 106K are not desired, and may even be described as excessive or wasteful, as the latter are actually deposits onto the pallet and not the electronic devices. The traditional spray coating operation 100 thus represents a waste of metallic material on the not desired surfaces 106A, 106C, 106E, 106F, 106G, 106I, and 106K. Further, the traditional spray coating operation 100B presents a cleanup challenge, as the pallet will require periodic cleaning to remove the metallic material, as the material is likely to build up over repetitive use of the pallets.

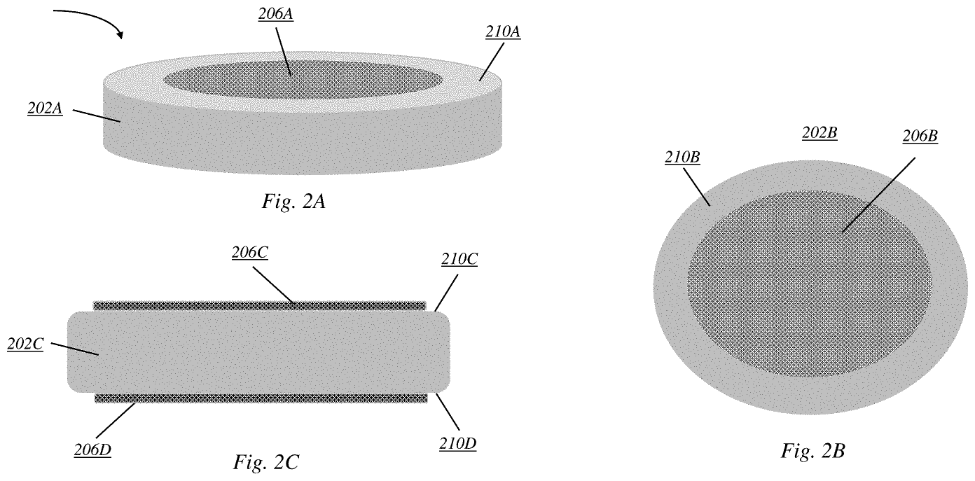

FIGS. 2A, 2B, and 2C features representative electronic devices, such as a MOV disk, according to exemplary embodiments (collectively, “electronic devices 202”). FIG. 2A is a perspective view of electronic device 202A, with an electrode 206A formed by depositing metallic material on a top surface (with the bottom surface not being visible). FIG. 2B is an overhead view of electronic device 202B, also with the electrode 206B formed by depositing metallic material on a top surface (with the bottom surface not being visible). FIG. 2C is a side view of electronic device 202C, with electrodes 206C and 206D formed by depositing metallic material on top and bottom surfaces, respectively (collectively, “electrode(s) 206”). Thus, the metallic material to form the electrodes 206 is applied to both a top surface and a bottom surface of the electronic device.

Further, in exemplary embodiments, the electrodes 206 only partially cover the top and bottom surfaces of the electronic device 202, with an edge portion of the device not being covered. This edge portion is known as a free zone. As used herein, the free zone is the non-spray area of the surface of the electronic device being sprayed. Thus, electronic device 202A includes free zone 210A; electronic device 202B includes free zone 210B; and electronic device 202C includes free zone 210C, on its top surface, and free zone 210D, on its bottom surface (collectively, “free zones 210”). In these examples, the free zones 210 are annular in shape and surround the edges of the electronic devices 202.

Where the shape of the electronic device to be sprayed is different than a circular disk, the metallic material deposition may assume a different shape. For example, if the electronic device is formed as a rectangular cube, then the metallic material may be rectangular in shape over top and bottom surfaces of the rectangular cube, with the dimension of the rectangle being slightly less than the dimension of a top (or bottom) surface of the rectangular cube so that a free zone not including the metallic material surrounds the surface of the electronic device. The electronic device may assume other shapes, including irregular shapes. As long as the electronic device includes substantially opposing surfaces, metallic material to form electrodes may be deposited on the opposing surfaces.

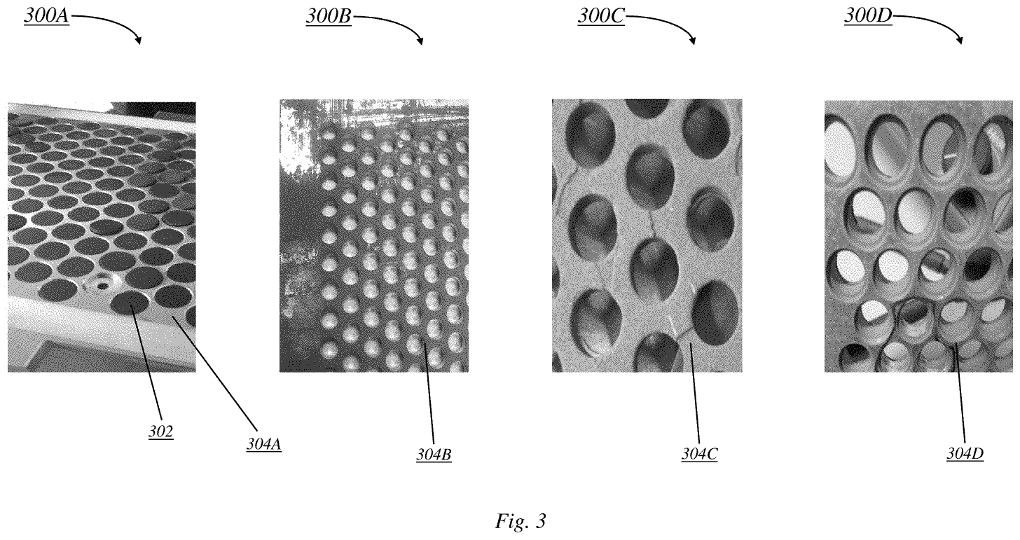

FIG. 3 features representative illustrations 300A, 300B, 300C, and 300D of pallets that have been used during the traditional spray coating operation, such as are illustrated in FIGS. 1A and 1B, according to exemplary embodiments. In illustration 300A, a pallet 304A is shown with an array of MOV disks 302 before a metallic material spraying operation. In illustrations 300B, 300C, and 300D, pallets 304B, 304C, and 304D, respectively, are shown, all following the metallic material spraying operation, and following removal of the MOV disks (collectively, “pallets 304”). The discoloration in illustrations 300B, 300C, and 300D show that the surface of the pallets 304B, 304C, and 304D are covered in the metallic spray used to form the electrodes on the MOV disks. In illustration 300D, it is evident that the metallic spray even gets embedded into the annular structures used to hold the MOV disks. Thus, the metallic spray is expected to build up upon the pallets 304 during repeated arc or flame spraying operations.

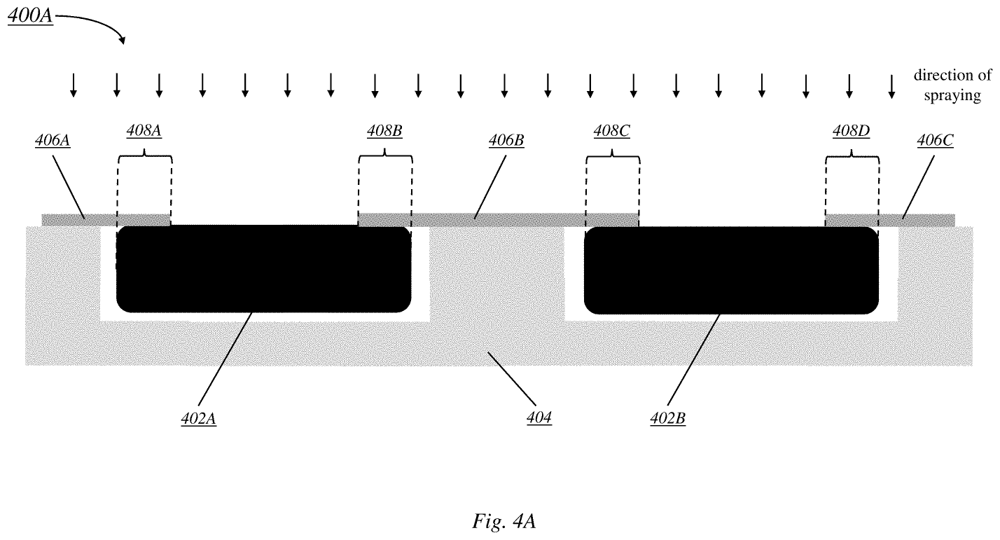

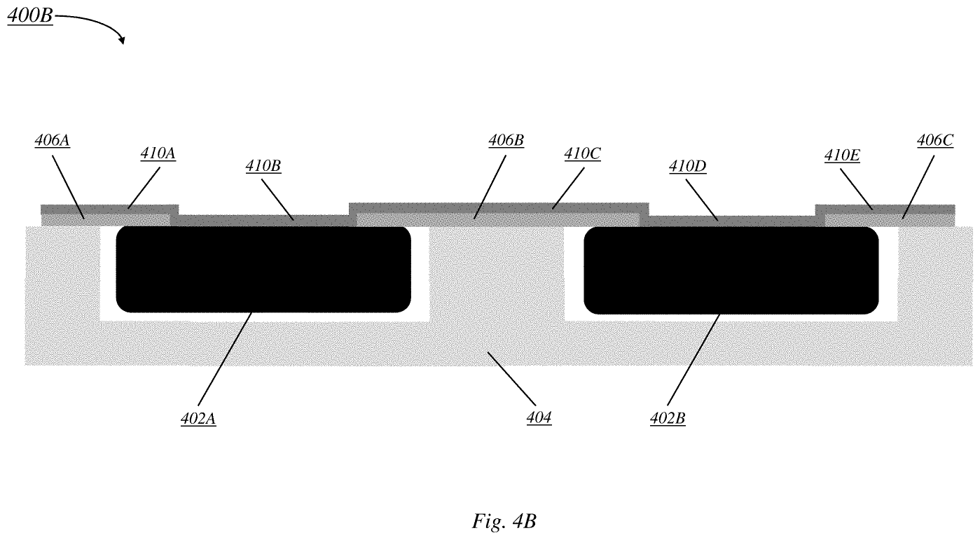

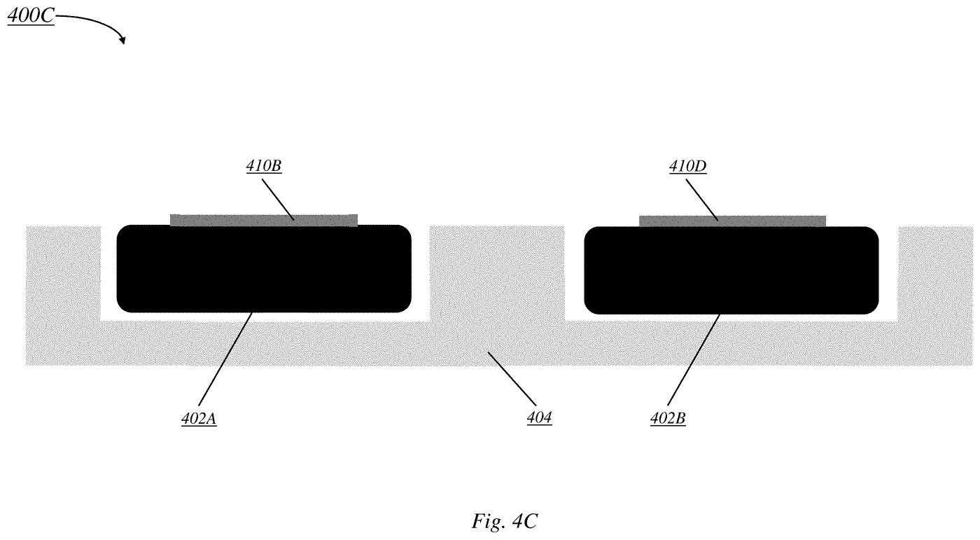

FIGS. 4A, 4B, and 4C are representative drawings illustrating a novel masking paper protection method, for coating electronic devices, according to exemplary embodiments. FIG. 4A shows a first stage 400A of the masking paper protection method; FIG. 4B shows a second stage 400B of the masking paper protection method; and FIG. 4C shows a third stage 400C of the masking paper protection method. Collectively, these stages make up the “masking paper protection method 400”. The masking paper protection method 400 features a blind hole pallet 404. Although the electronic device described herein feature a disk such as an MOV disk, the principles of the masking paper protection method 400 may be implemented on a variety of different electronic devices in which metallic spraying resulting in electrodes is to be performed.

In FIG. 4A, the first stage 400A of the masking paper protection method 400 features a pair of electronic devices 402A and 402B (collectively, “electronic devices 402”) disposed in receptacles a blind hole pallet 404. A blind hole pallet is one in which holes are made to a specific depth, without breaking through the other side of the material. The blind hole pallet may include receptacles for many electronic devices. In this example, the holes are for receiving the MOV disks (see e.g., illustration 300A in FIG. 3). With the blind hole pallet 404 in FIG. 4A, the electronic devices 402 are visible from above the pallet but not from below the pallet. Masking paper 406A, 406B, and 406C (collectively, “masking paper 406”) are disposed as shown over the visible side (top surface) of the electronic devices 402 as well as over adjacent portions of the blind hole pallet 404. The masking paper 406 is placed so as to cover free zones 408A, 408B, 408C, and 408D of the electronic devices 402 (collectively, “free zones 408”).

Recall from FIGS. 2A, 2B, and 2C that the free zone is the non-spray area of the electronic device being sprayed. Though the electrodes 206 cover a substantial portion of the top surface of the electronic device 202, they preferably do not cover the device surface entirely, but instead leave an edge portion uncovered on each side.

In the first stage 400A, the masking paper 406A covers free zone 408A of electronic device 402A, the masking paper 406C covers free zone 408D of electronic device 402B, and the masking paper 406B simultaneously covers both the free zone 408B of electronic device 402A and the free zone 408C of electronic device 402B. In an exemplary embodiment, during the spraying process, only the top surface of the electronic devices 402 would receive the sprayed metallic material and a bottom surface application would occur in a separate spraying process. Downward arrows show the direction in which metallic material will be sprayed over the assembly.

In the second stage 400B (FIG. 4B), metallic material 410 is sprayed over the top surface of the assembly. Metallic material 410A covers the masking paper 406A, metallic material 410B covers the top of the electronic device 402A, metallic material 410C covers the masking paper 406B, metallic material 410D covers the top of the electronic device 402B, and metallic material 410E covers the masking paper 406C.

In the third stage 400C (FIG. 4C), the masking paper 406 is removed. Any metallic material that is disposed on top of the masking paper 406 will also be removed. Thus, metallic material 410A, 410C, and 410E is removed, along with the respective portions of masking paper 406A, 406B, and 406C. Only metallic portions 410B and 410D remain, which are disposed over the respective electronic devices 402A and 402B. Further, there is no metallic material disposed on the blind hole pallet 404 or in any of the free zones of the electronic devices 402. The masking paper protection method 400 thus illustrates a way to avoid costly and time-consuming cleanup of the blind hole pallet 404.

In an exemplary embodiment, the masking paper 404 is supplemented with a plastic film material or metal foil, such as polyethylene terephthalate (PET), polyethylene (PE), or polyimide (PI) (plastic) films, or other materials to increase the strength of the masking paper. In one embodiment, the additional film facilitates easy removal of the masking paper 404, such that the paper may be readily peeled off following the spray process. In one embodiment, the masking paper 404 is supplemented with a thin adhesive film, enabling accurate placement of the masking paper upon the blind hole pallet before the spraying process begins. In some embodiments, in addition to being lower cost compared to thicker adhesive films, the thin adhesive film helps to keep the masking paper from cracking during the removal process.

Single layer masking paper, or single layer plastic film, or single layer metal foil material, provides an alternative solution to the above dual-layer solutions. For example, one layer may be masking paper while another layer is plastic film. With an adhesive layer on the bottom side facing the surface of the electronic device, this single layer material enables the same seal performance and the same peel off performance (e.g., no cracking during the removal process).

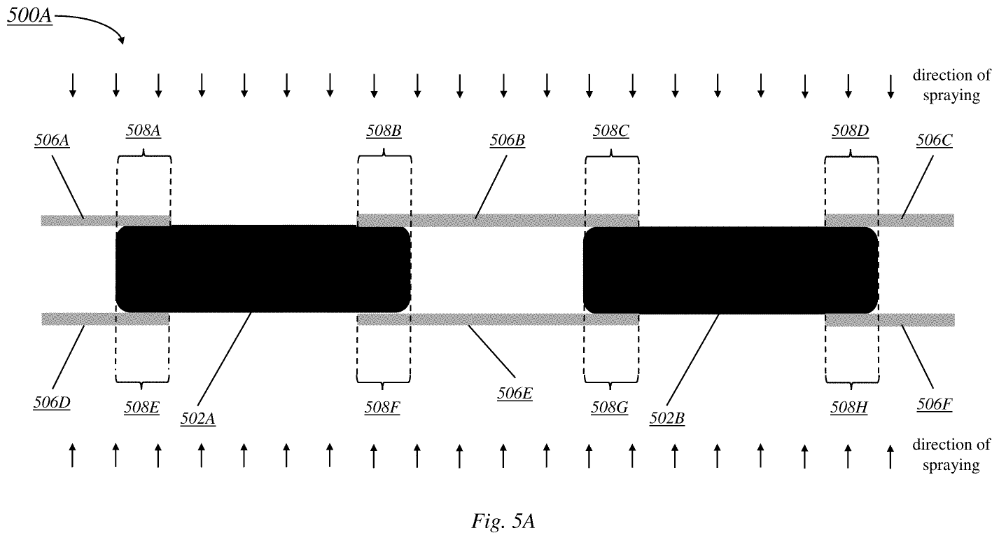

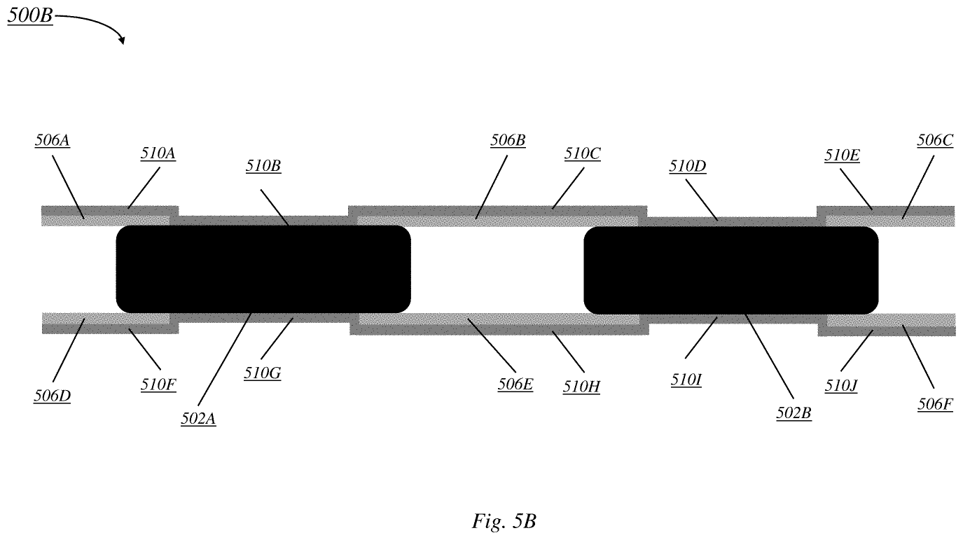

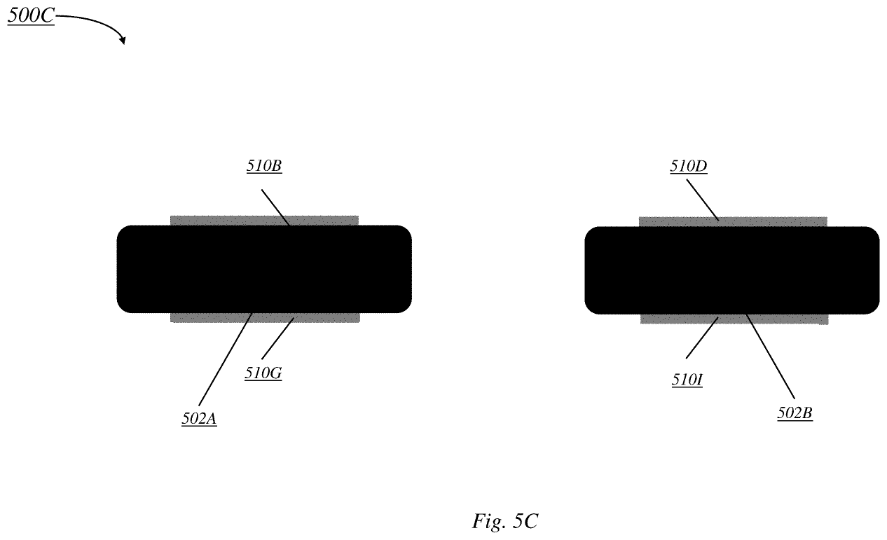

FIGS. 5A, 5B, and 5C are representative drawings illustrating a novel masking paper protection method, for coating electronic devices, according to exemplary embodiments. FIG. 5A shows a first stage 500A of the masking paper protection method; FIG. 5B shows a second stage 500B of the masking paper protection method; and FIG. 5C shows a third stage 500C of the masking paper protection method. Collectively, these stages make up the “masking paper protection method 500”. The masking paper protection method 500 features a pair of free-standing electronic devices and no pallet. Although the electronic device described herein feature a disk such as an MOV disk, the principles of the masking paper protection method 500 may be implemented on a variety of different electronic devices in which metallic spraying resulting in electrodes is to be performed.

In FIG. 5A, the first stage 500A of the masking paper protection method 500 features a pair of electronic devices 502A and 502B (collectively, “electronic devices 502”). In contrast to the blind hole pallet example above, the electronic devices 502 may be sprayed both from the top side and the bottom side, as both surfaces of the electronic devices are visible. Thus, masking paper is disposed on both sides of the electronic devices 502. Masking paper 506A, 506B, and 506C are disposed on the top side of the electronic devices 502 while masking paper 506D, 506E, and 506F (collectively, “masking paper 506”) are disposed over a bottom side of the electronic devices. The masking paper 506 is placed so as to cover free zones 508A, 508B, 508C, and 508D on the top side of the electronic devices 502 and to cover free zones 508E, 508F, 508G, and 508H on the bottom side of the electronic devices (collectively, “free zones 508”).

In the second stage 500B (FIG. 5B), metallic material 510 is sprayed over the top surface and the bottom surface of the assembly. On the top surface of the assembly, a first spraying operation causes metallic material 510A to cover the masking paper 506A, metallic material 510B to cover the top of the electronic device 502A, metallic material 510C to cover the masking paper 506B, metallic material 510D to cover the top of the electronic device 502B, and metallic material 510E to cover the masking paper 506C. On the bottom surface of the assembly a second spraying operation causes metallic material 510F to cover the masking paper 506D, metallic material 510G to cover the top of the electronic device 502A, metallic material 510H to cover the masking paper 506E, metallic material 510I to cover the top of the electronic device 502B, and metallic material 510J to cover the masking paper 506F.

In the third stage 500C (FIG. 5C), the masking paper 506 is removed. Any metallic material that is disposed on top of the masking paper 506 will also be removed. Thus, metallic material 510A, 510C, 510E, 510F, 510H, and 510J is removed, along with the respective portions of masking paper 506A, 506B, 506C, 506D, 506E, and 506F. Only metallic portions 510B, 510D, 510G, and 510I remain, the first two of which are disposed on a top surface of the respective electronic devices 502A and 502B, with the metallic portions 510G and 510I being disposed on a bottom surface. Further, there is no metallic material disposed in the free zones of either electronic device 502. The masking paper protection method 500 thus illustrates a way to quickly and easily cover desired portions of the electronic devices without use of a pallet. As in the previous example, the masking paper 506 may be supplemented with plastic film or adhesive to facilitate placement on the electronic devices.

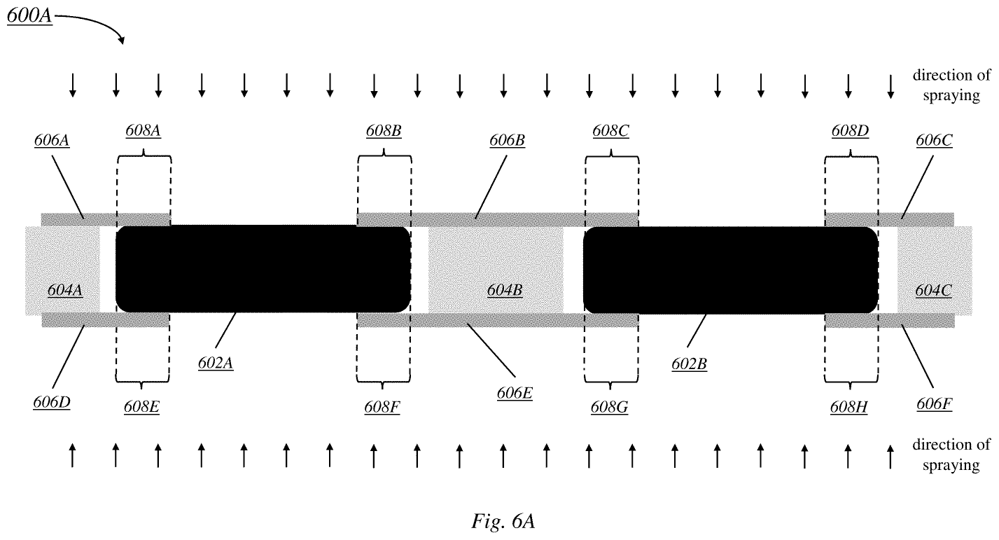

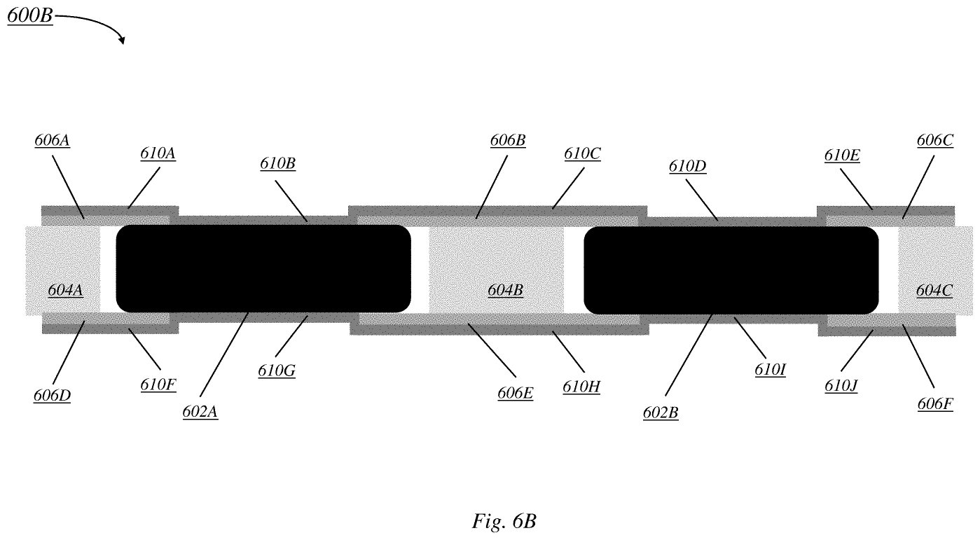

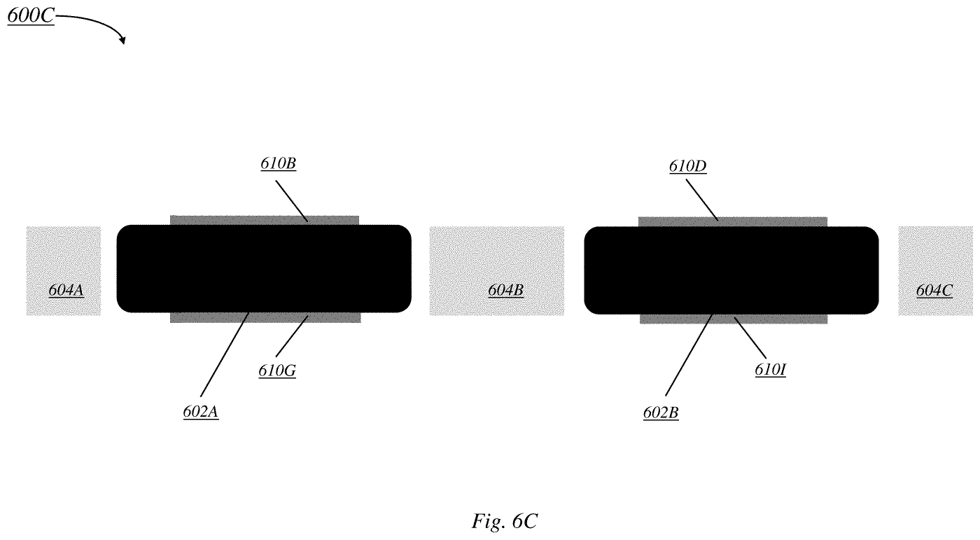

FIGS. 6A, 6B, and 6C are representative drawings illustrating a novel masking paper protection method, for coating electronic devices, according to exemplary embodiments. FIG. 6A shows a first stage 600A of the masking paper protection method; FIG. 6B shows a second stage 600B of the masking paper protection method; and FIG. 6C shows a third stage 600C of the masking paper protection method. Collectively, these stages make up the “masking paper protection method 600”. The masking paper protection method 600 features a through hole pallet 604. Although the electronic device described herein feature a disk such as an MOV disk, the principles of the masking paper protection method 600 may be implemented on a variety of different electronic devices in which metallic spraying resulting in electrodes is to be performed.

In FIG. 6A, the first stage 600A of the masking paper protection method 600 features a pair of electronic devices 602A and 602B (collectively, “electronic devices 602”) surrounded by a through hole pallet 604, where the electronic devices are inserted in receptacles of the through hole pallet. A through hole pallet is one in which holes are made through to the other side of the material. The through hole pallet may include receptacles for many electronic devices. Similar to the example with no pallet, the electronic devices 602 may be sprayed both from the top side and the bottom side, as both surfaces of the electronic devices are visible. Thus, masking paper is disposed on both sides of the electronic devices 602. In an exemplary embodiment, the electronic devices 602 are MOV disks. Masking paper 606A, 606B, and 606C are disposed on the top side of the electronic devices 602 while masking paper 606D, 606E, and 606F (collectively, “masking paper 606”) are disposed over a bottom side of the electronic devices. The masking paper 606 is placed so as to cover free zones 608A, 608B, 608C, and 608D on the top side of the electronic devices 602 and to cover free zones 608E, 608F, 608G, and 608H on the bottom side of the electronic devices (collectively, “free zones 608”).

In the second stage 600B (FIG. 6B), metallic material 610 is sprayed over the top surface and the bottom surface of the assembly. On the top surface of the assembly, a first spraying operation causes metallic material 610A to cover the masking paper 606A, metallic material 610B to cover the top of the electronic device 602A, metallic material 610C to cover the masking paper 606B, metallic material 610D to cover the top of the electronic device 602B, and metallic material 610E to cover the masking paper 606C. On the bottom surface of the assembly a second spraying operation causes metallic material 610F to cover the masking paper 606D, metallic material 610G to cover the top of the electronic device 602A, metallic material 610H to cover the masking paper 606E, metallic material 610I to cover the top of the electronic device 602B, and metallic material 610J to cover the masking paper 606F.

In the third stage 600C (FIG. 6C), the masking paper 606 is removed. Any metallic material that is disposed on top of the masking paper 606 will also be removed. Thus, metallic material 610A, 610C, 610E, 610F, 610H, and 610J is removed, along with the respective portions of masking paper 606A, 606B, 606C, 606D, 606E, and 606F. Only metallic portions 610B, 610D, 610G, and 610I remain, the first two of which are disposed on a top surface of the respective electronic devices 602A and 602B, with the metallic portions 610G and 610I being disposed on a bottom surface. Further, there is no metallic material disposed in the free zones of either electronic device 602 or on the through hole pallet 604. The masking paper protection method 600 thus illustrates a way to quickly and easily cover desired portions of the electronic devices as well as to avoid costly and time-consuming cleanup of the through hole pallet 604. As in the previous example, the masking paper 606 may be supplemented with plastic film or adhesive to facilitate placement on the electronic devices.

In exemplary embodiments, the masking paper protection methods 400, 500, 600 advantageously enable the application of metallic material by spraying such that the free zone areas of the electronic device are avoided, the underlying pallet (if used) is left clean throughout the process, and the methods easily adapt to automation applications. The masking paper can be pasted and removed easily. Further, in exemplary embodiments, the masking paper can be used in high temperature and high pressure environments. Also, the masking paper protection methods 400, 500, and 600 allow for different sizes and shapes of electronic devices. In exemplary embodiments, the masking paper protection methods 400, 500, and 600 can be used with MOV, TMOV, and iTMOV devices, which are manufactured by Littelfuse®. The masking paper may be made using a die cutting process and is easily placed onto the electronic device surface to ensure zero contamination from very hot and high pressure spray particles.

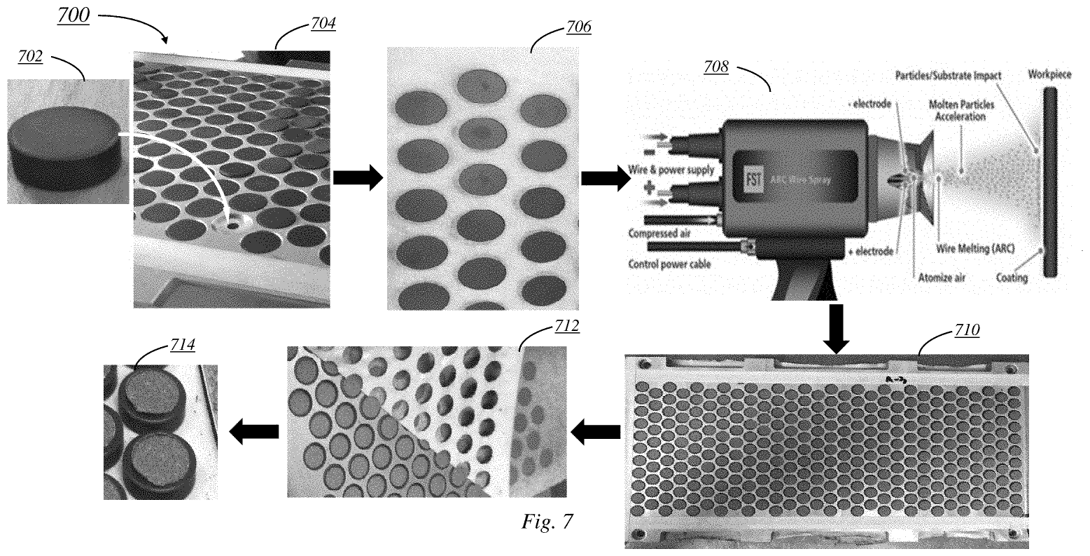

FIG. 7 is a pictorial flow diagram of a masking paper protection method 700, according to exemplary embodiments. An electronic device, in this case, a disk (block 702) is placed in a blind hole pallet (block 704). The assembly of electronic devices in the blind hole pallet is then covered with masking paper (block 706). An arc spraying operation deposits molten metallic particles upon the assembly (block 708), resulting in all electronic devices in the blind hole pallet being covered with metallic material (block 710). The masking paper is peeled away from the blind hole pallet (block 712). Notably missing from the blind hole pallet is the presence of any metallic material on the pallet. The end result is the covering of the electronic devices with the metallic material (electrodes) (block 714).

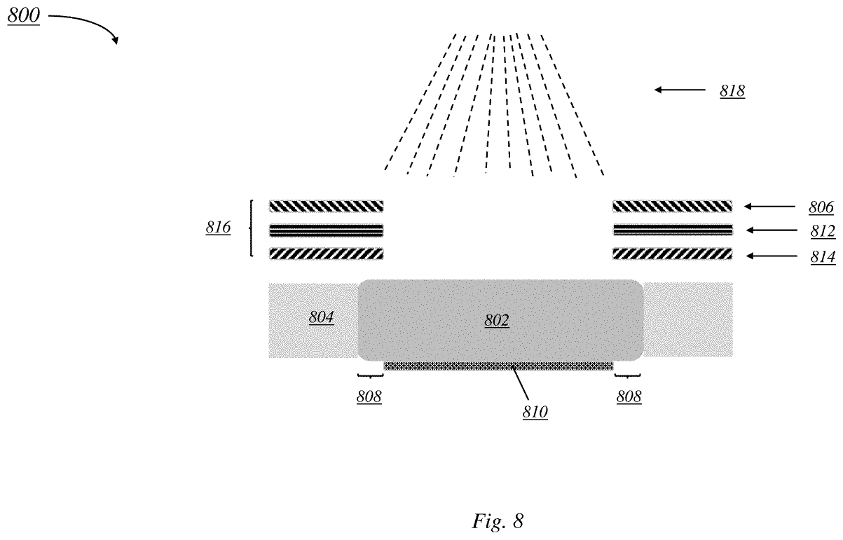

FIG. 8 is a representative drawing with an exploded view of the masking paper composition, according to exemplary embodiments. An electronic device 802 is shown, disposed within a pallet 804. The pallet 804 may be a through hole pallet, a blind hole pallet, or other type of structure designed to hold multiple electronic devices. An electrode 810 is visible on a bottom side of the electronic device 802, showing that the metallic material spraying process is completed for that side of the device. The top side of the electronic device 802, however, has not been sprayed with metallic material.

Three materials are shown above the top side of the electronic device 802 and form a covering 816 over the electronic device and pallet 804: masking paper 806, thin plastic film 812, and thin adhesive film 814. The thin plastic film 812 may be PET, PE, PI, or other material, and, in an exemplary embodiment, is used to strengthen the masking paper 806. In an alternative embodiment, the thin plastic film 812 may be replaced with a thin metal foil. Once the covering 816 is properly placed over the electronic device 312 and pallet 804, a metallic spraying operation 818 may commence. The thin adhesive film 814 facilitates accurate application of the covering 816 over the assembly consisting of electronic devices in a pallet. The thin adhesive film 814 also helps to keep the masking paper from cracking once the covering 816 is removed.

In an exemplary embodiment, as shown in FIG. 8, the thin adhesive film 814 is closest to the electronic device 802, with the thin plastic film 812 (or thin metal foil) being between the thin adhesive film 814 and the masking paper 806. The covering 816 thus ensures a good seal performance during the spraying operation 818 such that metal contamination is avoided on the free zones 808 of the electronic device 802 as well as the pallet 804. Further, the covering 816 ensures that there is no residual glue on the surface of the electronic device 802 after the covering is removed. In an exemplary embodiment, the thin adhesive film 814 is silicone gel, acrylic gel, or other glues that are able to ensure a good seal during the spraying operation 818, yet leave no residual materials after the covering 816 is removed.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. A masking paper protection method comprising:
inserting an electronic device into a receptacle of a blind hole pallet, the blind hole pallet comprising a plurality of receptacles for receiving a plurality of electronic devices;
covering the blind hole pallet with masking paper to form an assembly comprising the electronic device, the blind hole pallet, and the masking paper;
spraying the assembly with metallic material; and
removing the masking paper.

2. The masking paper protection method of claim 1, the covering operation further comprising covering a free zone of the electronic device.

3. The masking paper protection method of claim 2, further comprising coupling the masking paper with a thin plastic film.

4. The masking paper protection method of claim 2, further comprising coupling the masking paper with a thin adhesive film.

5. The masking paper protection method of claim 1, wherein the electronic device is a Metal Oxide Varistor (MOV) disk.

6. The masking paper protection method of claim 5, wherein the metallic material forms an electrode on the MOV disk.

7. The masking paper protection method of claim 1, wherein the assembly is sprayed with metallic material using an arc spraying process.

8. The masking paper protection method of claim 1, wherein the assembly is sprayed with metallic material using a flame spraying process.

9. A masking paper protection method comprising:
covering a top surface of an electronic device with first masking paper;
covering a bottom surface of the electronic device with second masking paper to form an assembly comprising the electronic device, the first masking paper, and the second masking paper;
spraying the assembly with metallic material; and
removing the first masking paper and the second masking paper from the electronic device.

10. The masking paper protection method of claim 9, further comprising:
covering a first free zone of the electronic device with the first masking paper; and
covering a second free zone of the electronic device with the second masking paper.

11. The masking paper protection method of claim 10, further comprising coupling the masking paper with a thin plastic film.

12. The masking paper protection method of claim 10, further comprising coupling the masking paper with a thin adhesive film.

13. The masking paper protection method of claim 9, wherein the electronic device is a Metal Oxide Varistor (MOV) disk and the metallic material forms an electrode on the MOV disk.

14. The masking paper protection method of claim 9, wherein the assembly is sprayed with metallic material using an arc spraying process.

15. The masking paper protection method of claim 9, wherein the assembly is sprayed with metallic material using a flame spraying process.

16. A masking paper protection method comprising:
inserting an electronic device into a receptacle of a through hole pallet, the through hole pallet comprising a plurality of receptacles for receiving a plurality of electronic devices;
covering a top surface of the through hole pallet with first masking paper;
covering a bottom surface of the through hole pallet with second masking paper to form an assembly comprising the electronic device, the through hole pallet, the first masking paper and the second masking paper;
spraying the assembly with metallic material; and
removing the first masking paper and the second masking paper.

17. The masking paper protection method of claim 16, further comprising:
covering a first free zone of the electronic device with the first masking paper; and
covering a second free zone of the electronic device with the second masking paper.

18. The masking paper protection method of claim 17, further comprising coupling the masking paper with a thin metal foil.

19. The masking paper protection method of claim 17, further comprising coupling the masking paper with a thin adhesive film.

20. The masking paper protection method of claim 17, wherein the electronic device is a Metal Oxide Varistor (MOV) disk and the metallic material forms an electrode on the MOV disk.
